(19) United States
(12) Patent Application Publication
(10) Pub. No.: US 2010/0157767 A1
(43) Pub. Date: Jun. 24, 2010

(54) METHOD FOR IDENTIFYING AN ABNORMAL DISC

(75) Inventors: Chia-Hsing HSU, Taoyuan County (TW); Pei-Kang Chen, Taoyuan County (TW); Yi-Long Hsiao, Taoyuan County (TW)

Correspondence Address: RABIN & Berdo, PC, 1101 14TH STREET, NW, SUITE 500, WASHINGTON, DC, 20005, US

(73) Assignee: QUANTA STORGAE INC., Taoyuan County (TW)

(21) Appl. No.: 12/563,508

(22) Filed: Sep. 21, 2009

(30) Foreign Application Priority Data
Dec. 22, 2008 (TW) 97150174

(51) Int. Cl. G11B 20/18

(52) U.S. Cl. 369/53.42; G9B/20.046

(57) ABSTRACT

A method for identifying an abnormal disc includes the steps of: forming three testing spherical aberration (SA) values including an SA value of a thinner data layer, a standard SA value and an SA value of a thicker data layer; adjusting to one of the testing SA values; performing focus for a target disc and recording a focus error signal; obtaining a maximum focus error signal and a corresponding testing SA value by way of comparison; and checking whether the corresponding testing SA value is equal to the standard SA value, and identifying the target disc as a normal disc if yes, or otherwise identifying the target disc as the abnormal disc and re-adjusting the SA value to enhance the signal quality.

This application claims the benefit of Taiwan application Serial No. 97150174, filed Dec. 22, 2008, the subject matter of which is incorporated herein by reference.

### BACKGROUND OF THE DISCLOSURE

1. Technical Field

The invention relates in general to a method for identifying an abnormal disc, and more particularly to a method of an optical drive for identifying an abnormal disc with a thinner or thicker disc substrate.

2. Description of the Related Art

An optical device, such as an objective lens, in an optical pick-up of an optical drive is relatively small. As for a small optical device, there are difficulties in regulating its material, shaping, curved surface and smoothness during the manufacture process, with the result that the luminance of the projecting light beam is not uniform, and the spherical aberration (SA) tends to occur. Thus, a focus spot of the light beam is presented with poor quality, which influences the correct reading for pits.

FIG. 1 (Prior Art) shows an SA calibration system disclosed in U.S. Pat. No. 6,756,574. As shown in FIG. 1, a laser device 2 of an optical pick-up 1 of an optical drive outputs a laser beam, which passes through multiple optical devices 3 and an SA calibration unit 4 and then travels to an objective lens 5 for focusing the light beam onto a data layer 7 of a disc 6. The light beam is reflected, by the data layer 7, back to the optical pick-up 1 and then refracted by the optical devices 3 to illuminate the light receiving surfaces A, B, C and D of an optical detector 8. A signal processing device 9 generates a focus error (FE) signal according to the corresponding detected signal of the light receiving surfaces A-D as being a combination of (A+C)−(B+D). The FE signal is transmitted to a micro-processor 10 which controls an actuator 11 to drive the movement of the objective lens 5, so as to focus the light beam onto the data layer 7.

In addition, the optical drive sets the SA value corresponding to the disc 6 and the standard thickness d of a disc substrate 12 neighboring the data layer 7 according to the specification of the disc 6. The micro-processor 10 outputs the control signal to an SA adjusting device 13 to adjust the distance between the lenses of the SA calibration unit 4, so as to change the projecting path of the light beam and improve the quality of the focus spot of the light beam. Thus, the light beam reflected from the data layer 7 back to the optical pick-up 1 can form the optimum signal.

However, the SA value is set by the optical drive according to the standard position of the data layer of the standard disc. The disc substrates may have thickness variations because the disc substrates are inaccurately manufactured by different manufacturers with different manufacture processes. Thus, the position of the data layer is changed. As for the abnormal disc having thinner or thicker substrate, using the SA value set by the standard specification fails to focus the light beam with optimum quality. Thus, in the servo system of the optical drive, the qualities of all signals are lowered, and the data read/write error or failure is presented. Thus, the optical drive still has problems in identifying the abnormal disc.

### SUMMARY OF THE DISCLOSURE

The disclosure is directed to a method for identifying an abnormal disc by using SA values of the disc having a normal, thinner, or thicker substrate to form three testing SA values, and performing the focus stroke tests according to the testing SA values, respectively. Thus, the abnormal disc may be identified according to the SA value corresponding to the maximum focus error signal.

The disclosure is also directed to a method for identifying an abnormal disc by using the SA value corresponding to the maximum focus error signal, which is obtained after abnormal disc is identified, to pre-calibrate the spherical aberration. Thus, the focus quality of the light beam may be optimized and the signal quality may be enhanced.

According to the present disclosure, a method of identifying an abnormal disc is provided. The method includes the steps of: forming three testing SA values comprising an SA value of a thinner data layer, a standard SA value and an SA value of a thicker data layer; adjusting to one of the testing SA values; performing focus for a target disk and recording a focus error signal; obtaining a maximum focus error signal and a corresponding testing SA value by way of comparison; checking whether the corresponding testing SA value is equal to the standard SA value, and identifying the target disc as an abnormal disc if no; re-adjusting the SA value and ending the step of identifying.

The disclosure will become apparent from the following detailed description of the preferred but non-limiting embodiments. The following description is made with reference to the accompanying drawings.

### BRIEF DESCRIPTION OF THE DRAWINGS

FIG. 1 (Prior Art) is a function block diagram showing a spherical aberration calibration system of a conventional optical drive.

FIG. 2 is a schematically cross-sectional view showing a disc.

FIG. 3 is a schematic illustration showing the process of the invention for identifying a normal data layer.

FIG. 4 is a schematic illustration showing the process of the invention for identifying a thinner data layer.

FIG. 5 is a schematic illustration showing the process of the invention for identifying a thicker data layer.

FIG. 6 is a flow chart showing a method of the invention for identifying an abnormal disc.

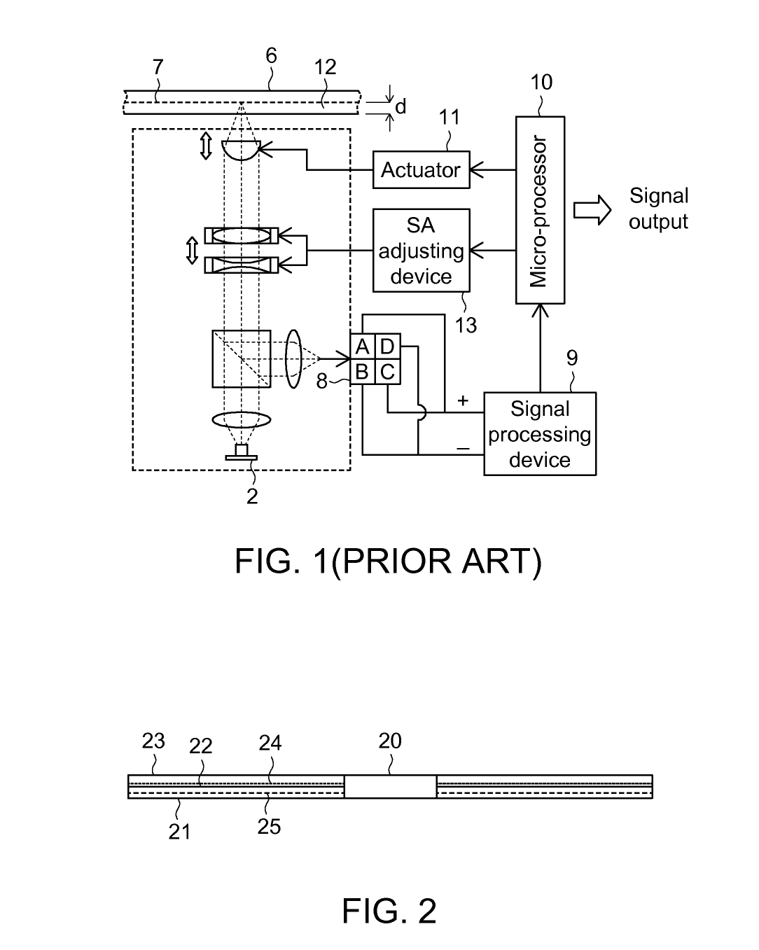

### DETAILED DESCRIPTION OF THE DISCLOSURE

FIG. 2 is a schematically cross-sectional view showing a disc 20. As shown in FIG. 2, the disc 20 is formed by coating a data layer 22 on a bottom substrate 21, and then covering a protection layer 23 over the data layer 22. The data layer 22 has a standard position according to the specification of various discs 20. The data layer 22 is located at a specific position of the disc according to the thickness of the substrate 21 so that pits are formed to record the data. The method for identifying the abnormal disc according to the invention is performed according to the property of the standard position of the data layer 22. Because the typical optical drive performs test for the standard positions of the data layers 22 set by various specifications of the discs 20, and stores corresponding standard SA values such that the optimum signal quality may be maintained. If the substrate 21 is thicker, the position of its data layer 24 is higher than that of the standard data layer 22. If the substrate 21 is thinner, the position of its data layer 25 is lower than that of the standard data layer 22. The abnormal disc is identified if it fails to meet the specification of the standard disc. For the abnormal disc, its spherical aberration cannot be correctly calibrated according to the standard SA value corresponding to the position of the standard data layer 22, so that the optimum signal quality on the focus cannot be obtained. Thus, the abnormal disc is desired to be identified so that the SA value can be adjusted in advance.

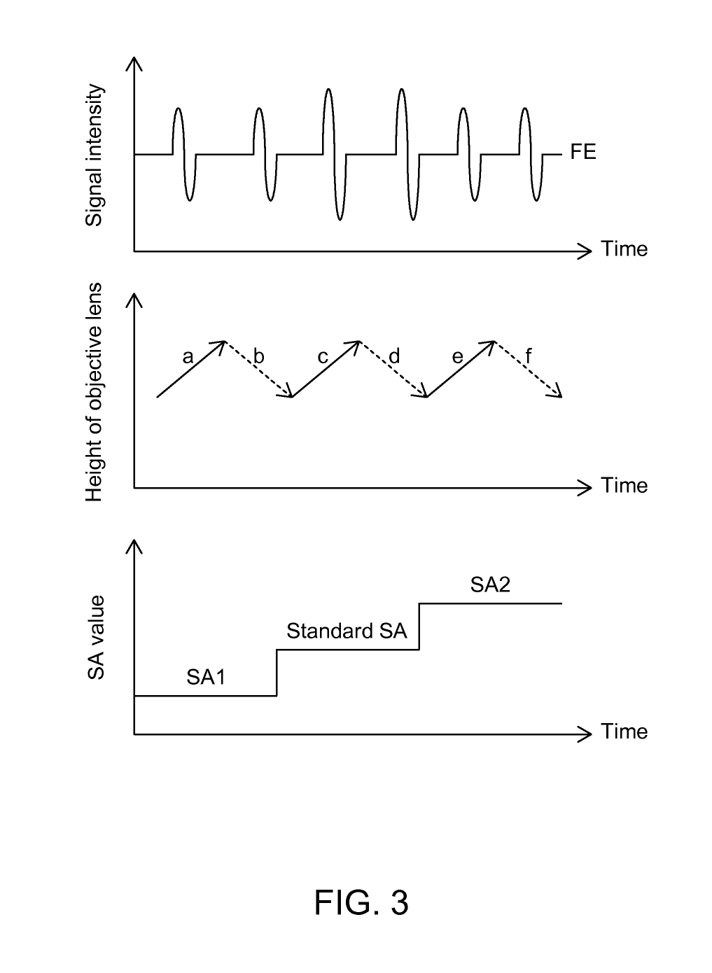

FIGS. 3 to 5 are schematic illustrations showing the processes of the invention for identifying normal, thinner and thicker data layers, respectively. The SA values are respectively adjusted to the SA1 value of the thinner data layer, the standard SA value and the SA2 value of the thicker data layer, and the objective lens is moved up and down to perform the focus stroke. Because the standard SA value is set to the standard position of the normal data layer, the optimum signal quality may be obtained for the focus spot projected on the standard position of the data layer. That is, its focus error signal reaches the maximum level. With regard to the standard SA value, the SA value is adjusted to a value corresponding to the thinner data layer, so that a focus error signal approximating the maximum level can also be obtained for the focus spot projected onto the position of the thinner data layer. On the other hand, the SA value is adjusted to a value correspond to the thicker data layer, so that a focus error signal approximating the maximum level can also be obtained for the focus spot projected onto the position of the thicker data layer.

The disc used in FIG. 3 is a normal disc, which has the data layer located at the position specified by the specification. The SA value is adjusted to the SA1 value of the thinner data layer, and the SA1 value is used to adjust spherical aberration with respect to the position of the thinner data layer. However, the data layer of the normal disc is located at the standard position instead of being located at the position of the thinner data layer. As a result, the level of the focus error signal, generated after the objective lens is moved up and down through focus strokes a and b, rises but does not reach its maximum. After that, the SA value is adjusted to the standard SA value, and the SA value is used to adjust spherical aberration with respect to the position of the standard data layer. Then, the objective lens is again moved up and down through the focus strokes c and d, and the focus error signal with the maximum level is obtained for the standard data layer. Next, the SA value is adjusted to the SA2 value of the thicker data layer, and the SA2 value is the used to adjust the spherical aberration with respect to the position of the thicker data layer. Because the data layer of the normal disc is located at the standard position instead of being located at the position of the thicker data layer, the level of the focus error signal, generated after the objective lens is moved up and down through the focus strokes e and f, rises but does not reach its maximum.

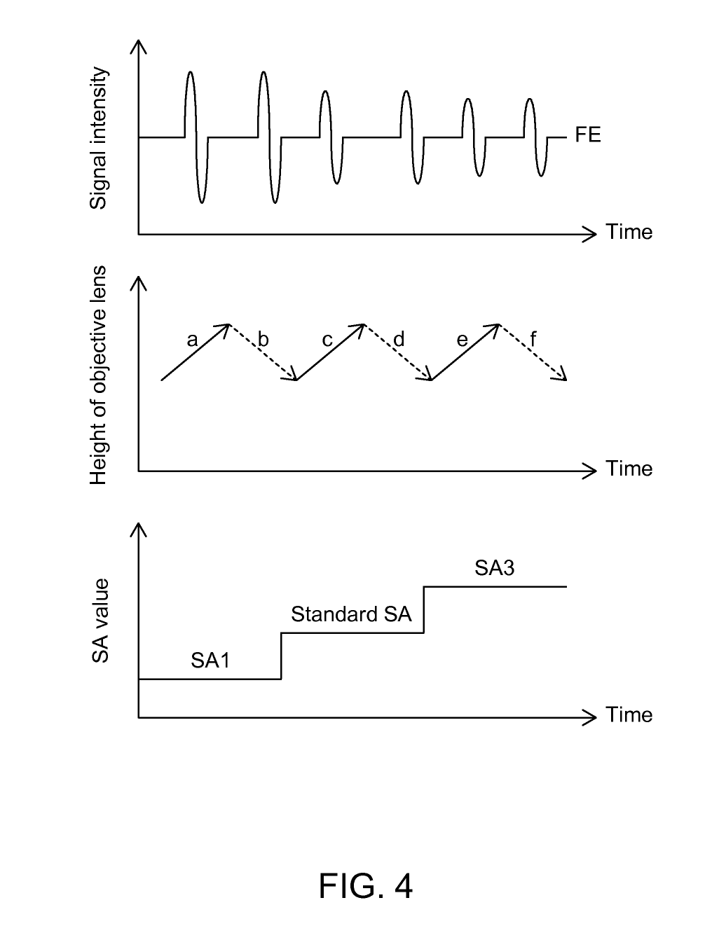

The disc used in FIG. 4 is the disc with the thinner data layer. The SA value is adjusted to the SA1 value of the thinner data layer. Because the data layer of the disc is located at the position of the thinner data layer, the level of the focus error signal, generated after the objective lens is moved up and down through the focus strokes a and b, reaches its maximum level. Then, the SA value is adjusted to the standard SA value, and the objective lens is moved up and down through the focus strokes c and d. The standard SA value is used to adjust spherical aberration with respect to the position of the standard data layer. Because the thinner data layer is not located at the standard position, the level of the generated focus error signal rises but is still relatively low. Then, the SA value is adjusted to the SA2 value of the thicker data layer. The level of the focus error signal, generated after the objective lens is moved up and down through the focus strokes e and f, rises because the thinner data layer is not located at the position of the thicker data layer. However, the level of the signal is relatively low and is the lowest thereof because the distance from the position of the thicker data layer to the thinner data layer is longer.

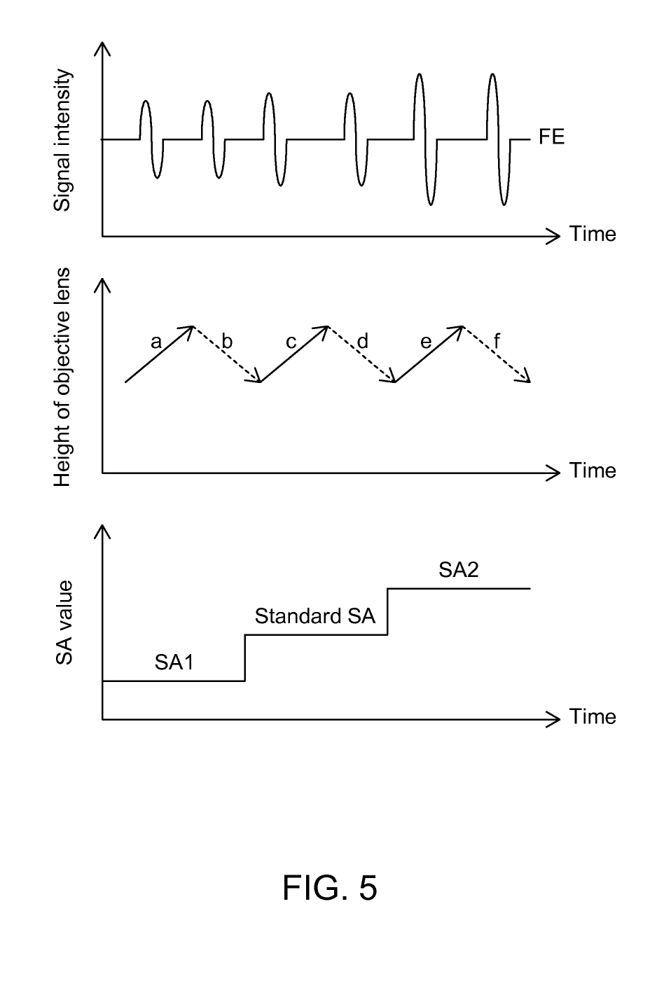

The disc used in FIG. 5 is the disc with the thicker data layer. The SA value is adjusted to the SA1 value of the thinner data layer. Because the thicker data layer is not located at the position of the thinner data layer, the level of the focus error signal, generated after the objective lens is moved through the focus strokes a and b, rises. However, the level of the signal is relatively low and is the lowest thereof because the distance from the position of the thinner data layer to the thicker data layer is longer. After that, the SA value is adjusted to the standard SA value, and the objective lens is moved up and down through the focus strokes c and d. The standard SA value is used to adjust spherical aberration with respect to the position of the standard data layer. Because the thinner data layer is not located at the standard position, the level of the generated focus error signal rises but is relatively higher since the distance from the standard data layer to the thicker data layer is shorter. Next, the SA value is adjusted to the SA2 value of the thicker data layer. Because the data layer is located at the position of the thicker data layer, the focus error signal with the maximum level is obtained after the objective lens is moved up and down through the focus strokes e and f.

According to the results of the SA values with respect to the variations of the focus error signals, obtained in FIGS. 3 to 5, the focus error signal with the maximum level changes with the change of the position of the data layer. As for any disc, the SA values are respectively adjusted to the SA1 value of the thinner data layer, the standard SA value and the SA2 value of the thicker data layer, and the objective lens is moved up and down to perform the focus strokes. A maximum focus error signal is obtained from the generated focus error signals by way of comparison. The SA value corresponding to the maximum focus error signal is compared with the standard SA value. If the SA value is the same as the standard SA value, the disc is identified as a normal disc. If the SA value is different from the standard SA value, the disc is identified as an abnormal disc. When the disc is identified as an abnormal disc, the identified result can be provided to the optical drive as a reference for servo control, or for adjusting the SA value to a better position before servo control. Therefore, the spherical aberration of the abnormal disc can be correctly calibrated.

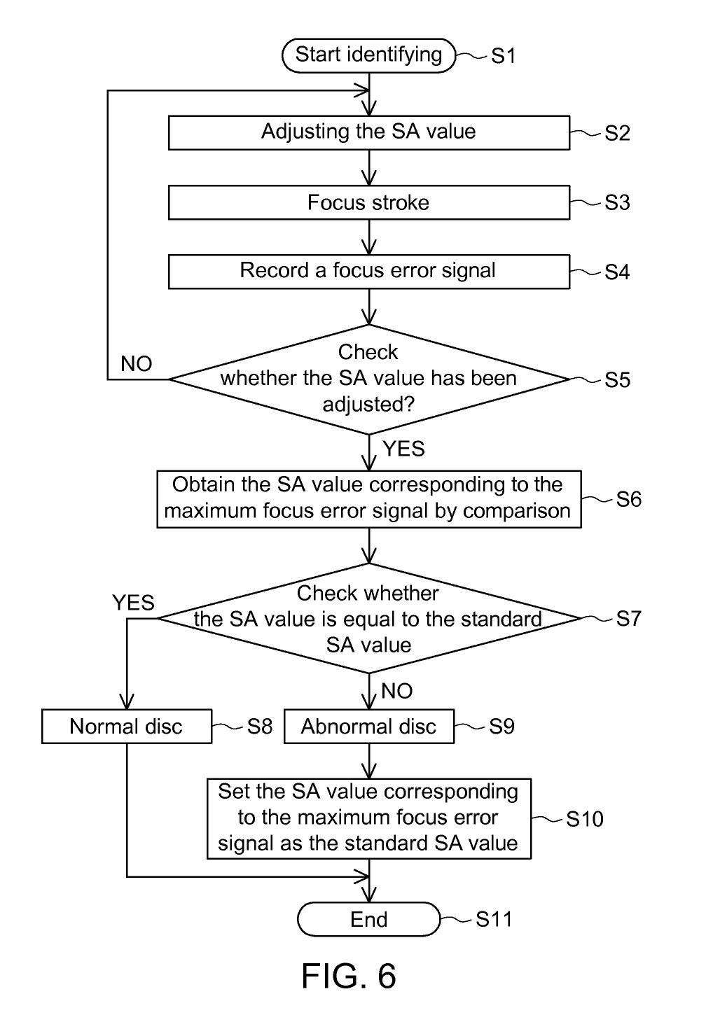

FIG. 6 is a flow chart showing a method of the invention for identifying an abnormal disc. The invention uses different SA values to sequentially perform focus strokes, and identifies the abnormal disc with an SA value corresponding to the maximum focus error signal according to the following steps. In step S1, the method starts to identify an abnormal disc before the optical drive has not performed servo control. In step S2, three testing SA values, including the SA1 value of the thinner data layer, the standard SA value and the SA2 value of the thicker data layer, are formed from an addition or a subtraction between the standard SA value and a predetermined difference, and the SA value is adjusted to one of the three testing SA values alternately. Then, in step S3, the objective lens is moved to perform the focus stroke. With respect to each testing SA value, the objective lens may be continuously moved up and down through the focus stroke to ensure that the focus error signal is obtained during the focus stroke. In step S4, the focus error signal is recorded. Next, in step S5, it is checked whether the SA value has been adjusted to the three testing SA values. If not, the process goes back to the step S2 to adjust the next testing SA value to continue testing. If yes, the process enters step S6.

In the step S6, the maximum focus error signal and its corresponding testing SA value are determined according to the focus error signals recorded in the step S4 by way of comparison. Then, the process enters step S7 to check whether the corresponding testing SA value is equal to the standard SA value. If the corresponding testing SA value is equal to the standard SA value, it is determined that the maximum focus error signal appears at the position of the standard data layer, and the process can enter step S8 to identify the disc as the normal disc. Finally, the process enters step S11 to end the identifying process. If the corresponding testing SA value is not equal to the standard SA value, it is determined that the appearing position of the maximum focus error signal is not located at the position of the standard data layer, and the process enters step S9 to identify the disc as the abnormal disc. Then, the process enters step S10 to: provide a reference to the optical drive for servo control; set the corresponding testing SA value as the standard SA value; or allow the optical drive to re-adjust for an optimum SA value. After that, the process enters the step S11 to end the identifying process.

Thus, the method of the invention for identifying the abnormal disc can form three testing SA values according to the SA values of the normal disc, the thinner disc or the thicker disc. Then, the focus stroke tests are sequentially performed, and the SA value corresponding to the maximum focus error signal is compared with the standard SA value so that the abnormal disc is identified. The method of the invention for identifying the abnormal disc can calibrate the spherical aberration in advance according to the identified abnormal disc such that the focus of the light beam has the optimum quality, and the signal quality can be enhanced.

While the disclosure has been described by way of example and in terms of a preferred embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of identifying an abnormal disc, the method comprising the steps of:
(a) forming three testing spherical aberration (SA) values comprising an SA value of a thinner data layer, a standard SA value and an SA value of a thicker data layer;
(b) adjusting to one of the testing SA values;
(c) performing focus for a target disc and recording a focus error signal;
(d) obtaining a maximum focus error signal and a corresponding testing SA value by way of comparison;
(e) checking whether the corresponding testing SA value is equal to the standard SA value, and identifying the target disc as a normal disc if yes, or otherwise identifying the target disc as the abnormal disc; and
(f) ending the step of identifying.

2. The method according to claim 1, wherein the step of identifying is executed before an optical drive has not performed servo control.

3. The method according to claim 1, wherein the three testing SA values are formed from an addition or a subtraction operation for the standard SA value.

4. The method according to claim 3, wherein the three testing SA values are formed from an addition or a subtraction between the standard SA value and a predetermined difference.

5. The method according to claim 1, further comprising, after the step (c), the steps of:
(c1) checking whether the three testing SA values have been adjusted, and going back to the step (b) to adjust the unrepeated testing SA values to continue testing if not, or otherwise entering the step (d).

6. The method according to claim 1, wherein the step of performing focus is executed by moving a focus stroke continuously upward and downward for each testing SA values.

7. The method according to claim 1, wherein in the step (e), when the target disc is identified as the abnormal disc, the testing SA value corresponding to the maximum focus error signal is set as the standard SA value.

8. The method according to claim 1, wherein in the step (e), when the target disc is identified as the abnormal disc, an optimum SA value is re-adjusted.

9. The method according to claim 1, wherein in the step (e), when the target disc is identified as the abnormal disc, a reference is provided to the optical drive for servo control.
